(19) United States
(12) Patent Application Publication
(10) Pub. No.: US 2025/0178223 A1
(43) Pub. Date: Jun. 5, 2025

(54) Shaver Featuring Shaver Head with Double-Layer Elastic Structure

(71) Applicant: ZHONGSHAN ASIABLADE CO., LTD., Zhongshan, Guangdong Province (CN)

(72) Inventors: Ziyi DONG, Zhongshan (CN); Hua XIAO, Zhongshan (CN)

(21) Appl. No.: 18/554,829

(22) PCT Filed: Feb. 14, 2023
(86) PCT No.: PCT/CN2023/075996

§ 371 Date: Feb. 4, 2025

(30) Foreign Application Priority Data
May 10, 2022 (CN) 202210504412.3

(51) Int. Cl. B26B 19/06; B26B 19/38

(52) U.S. Cl. CPC B26B 19/063; B26B 19/3873

(57) ABSTRACT

The invention discloses a shaver featuring a shaver head with a double-layer elastic structure, which is characterized by comprising a shaver head and a main body, wherein the shaver head comprises an upper shaver head shell and a lower shaver head shell; a connecting rod is arranged on a bottom surface of the lower shaver head shell; a moving blade connector, a first moving blade and a second moving blade fixing part are arranged above the lower shaver head shell; and a first stationary blade, a second stationary blade and a second moving blade are mounted on the upper shaver head shell. The shaver of the invention can trim long hair and short hair at the same time, a first elastic part is arranged between the moving blade connector and the lower shaver head shell, and a second elastic part is arranged between the second moving blade fixing part and the moving blade connector; the shaver head adopts a single drive, four springs divided into two groups, and a balance limit structure, so as to provide stable elastic force for the first moving blade and the second moving blade, prevent the two groups of blades from interfering with each other, and guarantee force balance; consequently, the shaver achieves enhanced working stability, improved shaving effect, while minimizing the risk of skin scratches.

### TECHNICAL FIELD

The invention relates to a shaver featuring a shaver head with a double-layer elastic structure.

### DESCRIPTION OF RELATED ARTS

There are currently two types of shaver heads available for trimming body hair in the market.

One is professional equipment, which cuts long hair and short hair separately. Long hair is trimmed first with hair scissors. After trimming, the hair length remains slightly longer than 1 mm, so there will be noticeable hair residue. Then a reciprocating shaver or razor is used to completely remove the remaining short hair, ensuring a visually appealing and comfortable result. The trimming process is time-consuming and requires the use of various tools.

The other type is a regular body hair trimmer which can trim long hair and short hair at the same time. However, due to the structural and technological characteristics, the cutting efficiency of such hair trimmer is low. Additionally, a significant concern is that a moving blade and a stationary blade make direct contact with the skin, which poses potential safety hazards and increases the risk of skin injuries, thus resulting in an unsatisfactory user experience.

### SUMMARY OF THE PRESENT INVENTION

### Technical Problem

Both body hair trimmers and shavers commonly suffer from a shared drawback, namely, a lack of elasticity in the moving blade, which results in rapid wear of the moving blade; or an elastic structure is too complicated and the shaver head structure is not compact enough.

### Technical Solution

The invention aims to overcome the problems in the prior art that two moving blades of a shaver head which can trim short hair and long hair simultaneously lack elasticity or have an excessively complex elastic structure, and provides a shaver featuring a shaver head with a double-layer elastic structure.

The invention is realized by the following technical scheme.

A shaver featuring a shaver head with a double-layer elastic structure comprises a shaver head 1 and a main body 2, wherein the shaver head 1 comprises an upper shaver head shell 3 and a lower shaver head shell 4 which are fixedly connected; a connecting rod 12 for being connected with the main body 2 is arranged on a bottom surface of the lower shaver head shell 4; a moving blade connector 5 for driving a blade to move is arranged above the lower shaver head shell 4; the moving blade connector 5 is provided with a first moving blade 6 and a second moving blade fixing part 8 which move together with the moving blade connector 5; a first stationary blade 7 is mounted on the upper shaver head shell 3, and the first moving blade 6 abuts against a lower surface of the first stationary blade 7; the second moving blade fixing part 8 is provided with a second moving blade 9 which moves together with the second moving blade fixing part 8; a second stationary blade 10 abuts against the second moving blade 9; and first elastic parts 13 are arranged between the lower shaver head shell 4 and the moving blade connector 5, and second elastic parts 14 are arranged between the moving blade connector 5 and the second moving blade fixing part 8.

According to the shaver featuring the shaver head with the double-layer elastic structure, first sleeve posts 505 are arranged on two sides of a bottom surface of the moving blade connector 5, mounting grooves 402 for inserting the first sleeve posts 505 are formed in the lower shaver head shell 4, and the first elastic parts 13 are sleeved on the first sleeve posts 505; and a lower end of the first elastic part 13 abuts against the corresponding mounting groove 402, and an upper end abuts against the bottom surface of the moving blade connector 5.

According to the shaver featuring the shaver head with the double-layer elastic structure, second sleeve posts 506 are arranged on two sides of an upper surface of the moving blade connector 5, and the second sleeve post 506 is provided with a central hole 507; three sleeve posts 802 are arranged on two sides of a bottom surface of the second moving blade fixing part 8 corresponding to the second sleeve posts 506, and the three sleeve posts 802 are inserted into the central hole 507; and the second elastic parts 14 are sleeved on the second sleeve posts 506 and the third sleeve posts 802, a lower end of the second elastic part 14 abuts against the corresponding second sleeve post 506, and an upper end abuts against the corresponding third sleeve post 802.

According to the shaver featuring the shaver head with the double-layer elastic structure, the first stationary blade 7 is provided with a plurality of stationary blade teeth 701 extending outward, the first moving blade 6 is provided with a plurality of moving blade teeth 604 extending outward, and the stationary blade teeth 701 are longer than the moving blade teeth 604; and a tip of the stationary blade tooth 701 is an arc end, one surface of the arc end is an arc surface protruding towards the stationary blade tooth 701, and an opposite surface is flush with a surface of the stationary blade tooth 701.

According to the shaver featuring the shaver head with the double-layer elastic structure, the second stationary blade 10 and the second moving blade 9 are both made by stainless steel stamping and acute angle etching processes.

According to the shaver featuring the shaver head with the double-layer elastic structure, the second stationary blade 10 and the second moving blade 9 are arranged in the middle of the shaver head 1, the second stationary blade 10 is in a mesh shape, and a plurality of hair inlet holes 101 are densely formed in the second stationary blade 10; and the second moving blade 9 is provided with a plurality of elongated hole-shaped cutting edges 901, a 45° angle is formed between the cutting edges 901 and the horizontal plane, and the cutting edges 901 abut against an inner side surface of the second stationary blade 10.

According to the shaver featuring the shaver head with the double-layer elastic structure, a first through hole 401 is formed in the lower shaver head shell 4, two engage blocks 501 extending downward through the first through hole 401 are arranged on a bottom surface of the moving blade connector 5, and an engage groove 502 is arranged between the two engage blocks 501 for being linked with a transmission device in the main body 2; and
the main body 2 comprises an outer main body shell 20 and an inner main body shell 21, a shaver head connector 22 is arranged over the outer main body shell 20, a motor 25 is arranged at the top of the interior of the outer main body shell 20, a rotating swing part 26 for driving the moving blade connector 5 to reciprocate is mounted on a motor shaft of the motor 25, and an upper end of the rotating swing part 26 is placed in the engage groove 502.

According to the shaver featuring the shaver head with the double-layer elastic structure, the shaver head 1 is rotatably clamped on the shaver head connector 22 through the connecting rod 12, a lower end of the shaver head connector 22 is detachably arranged at the top of the main body 2, a pry bar 28 and an elastic piece 27 are arranged in the shaver head connector 22, the connecting rod 12 is provided with an insertion hole 29, one end of the pry bar 28 abuts against the elastic piece 27, and the other end is inserted into the insertion hole 29.

According to the shaver featuring the shaver head with the double-layer elastic structure, two ends of the shaver head 1 are provided with cleaning holes 15.

According to the shaver featuring the shaver head with the double-layer elastic structure, the first moving blade 6 is provided with a plurality of mounting holes 603, the moving blade connector 5 is correspondingly provided with a plurality of mounting posts 503 inserted into the mounting holes 603, the first stationary blade 7 is provided with a plurality of positioning holes 704, and a bottom surface of the upper shaver head shell 3 is correspondingly provided with a plurality of first positioning posts 301 inserted into the positioning holes 704;
snap-fit grooves 705 are formed in the first stationary blade 7, snap-fit pieces 102 fitted into the snap-fit grooves 705 are arranged on an outer side of the second stationary blade 10, snap-fit holes 103 are formed in the snap-fit pieces 102, and the upper shaver head shell 3 is provided with snap-fit heads 302 fitted into the snap-fit holes 103;
a step 803 is arranged on an outer side of the second moving blade fixing part 8, a bottom of the second moving blade 9 is placed on the step 803, positioning grooves 902 are formed in an outer side of the second moving blade 9, and the second moving blade fixing part 8 is provided with second positioning posts 804 fitted into the positioning grooves 902; and
two upward extending clip plates 504 are arranged on the moving blade connector 5, downward extending receiving holes 801 are formed in two sides of the second moving blade fixing part 8, and the clip plates 504 are fastened into the receiving holes 801.

### Beneficial Effects

The shaver of the invention can trim long hair and short hair at the same time, the first elastic part is arranged between the moving blade connector and the lower shaver head shell, and the second elastic part is arranged between the second moving blade fixing part and the moving blade connector; the shaver head adopts a single drive, four springs divided into two groups, and a balance limit structure, so as to provide stable elastic force for the first moving blade and the second moving blade, allow the first moving blade to be attached to the first stationary blade and the second moving blade to be attached to the second stationary blade, prevent the two groups of blades from interfering with each other, and guarantee force balance; consequently, the shaver achieves enhanced working stability, improved shaving efficiency and effect, while minimizing the risk of skin scratches.

The shaver features a compact internal structure with a transmission positioning structure that offers precision within ±0.02 mm. Additionally, the shaver head has the flexibility to swing and adapt to the contours of the skin.

According to the shaver, the cleaning holes are formed in the two ends of the shaver head, and after shaving, the shaver head can be directly washed under a faucet, so that hair remaining in the shaver can be easily removed through the cleaning holes, ensuring convenient and thorough cleaning.

### BRIEF DESCRIPTION OF THE DRAWINGS

FIG. 1 is a perspective view of the shaver;

FIG. 2 is a rear view of the shaver;

FIG. 3 is a sectional view of the shaver;

FIG. 4 is a first sectional view of a shaver head;

FIG. 5 is a second sectional view of a shaver head;

FIG. 6 is a first exploded view of a shaver head;

FIG. 7 is a second exploded view of a shaver head;

FIG. 8 is a first exploded view of a main body;

FIG. 9 is a second exploded view of a main body;

FIG. 10 is a first exploded view of the shaver; and

FIG. 11 is a second exploded view of the shaver.

Included in the figures are: 1 shaver head; 2 main body; 3 upper shaver head shell; 301 first positioning post; 302 snap-fit head; 4 lower shaver head shell; 401 first through hole; 402 mounting groove; 5 moving blade connector; 501 engage block; 502 engage groove; 503 mounting post; 504 clip plate; 505 first sleeve post; 506 second sleeve post; 507 central hole; 6 first moving blade; 601 first elongated hole; 602 second through hole; 603 mounting hole; 604 moving blade tooth; 7 first stationary blade; 701 stationary blade tooth; 702 second elongated hole; 703 slotted hole; 704 positioning hole; 705 snap-fit groove; 8 second moving blade fixing part; 801 receiving hole; 802 third sleeve post; 803 step; 804 second positioning post; 9 second moving blade; 901 cutting edge; 902 positioning groove; 10 second stationary blade; 101 hair inlet hole; 102 snap-fit piece; 103 snap-fit hole; 11 hair guiding comb tooth; 12 connecting rod; 13 first elastic part; 14 second elastic part; 15 cleaning hole; 20 outer main body shell; 21 inner main body shell; 22 shaver head connector; 23 upper connector; 24 lower connector; 25 motor; 26 rotating swing part; 27 elastic piece; 28 pry bar; 29 insertion hole; 30 limit hole; 31 key; 32 charging interface; 33 battery; 34 circuit board.

### DETAILED DESCRIPTION OF THE PREFERRED EMBODIMENT

The technical feature of the invention will be further described in detail with reference to the accompany drawings, so as to be understood by those skilled in the art.

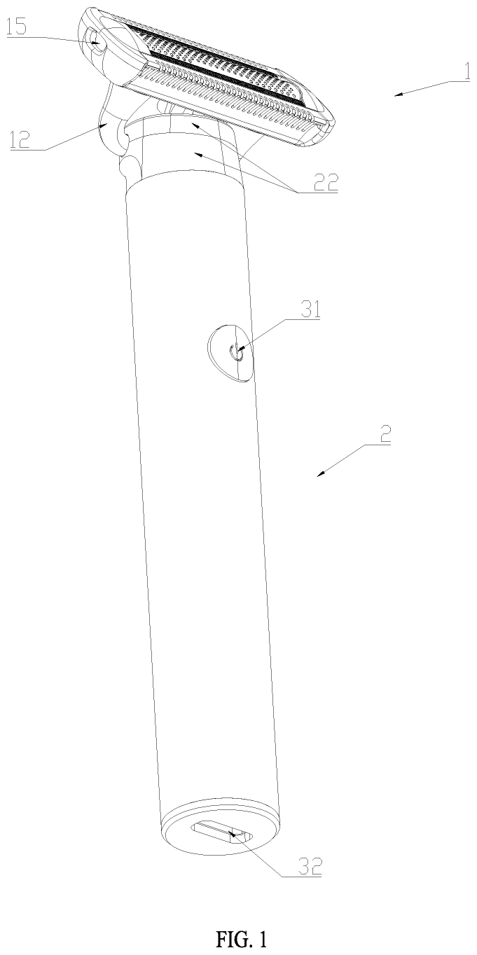

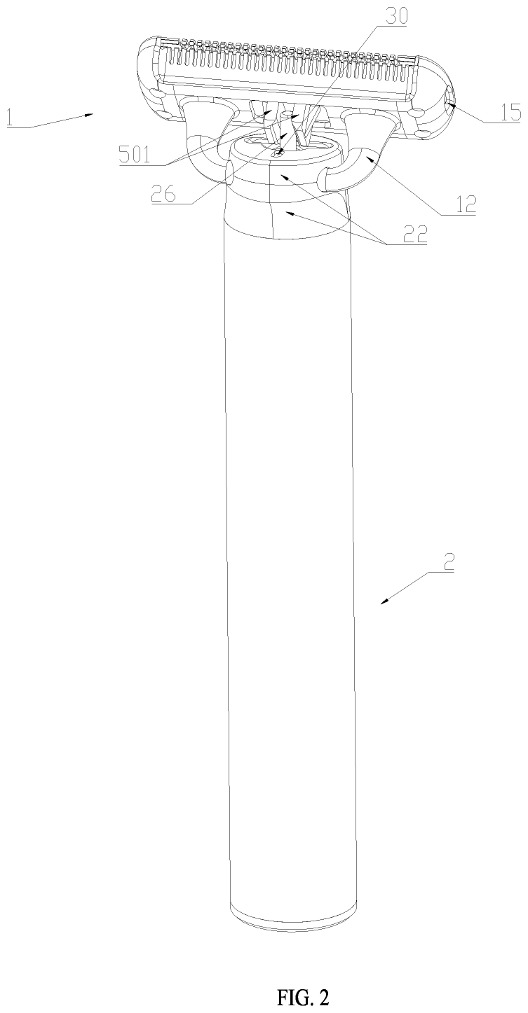

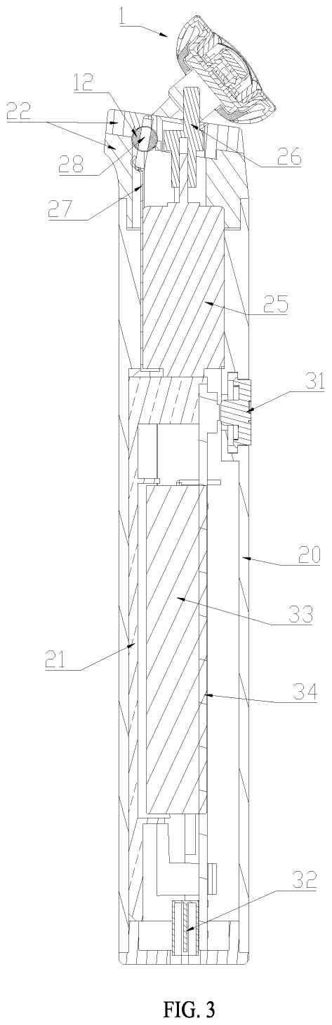

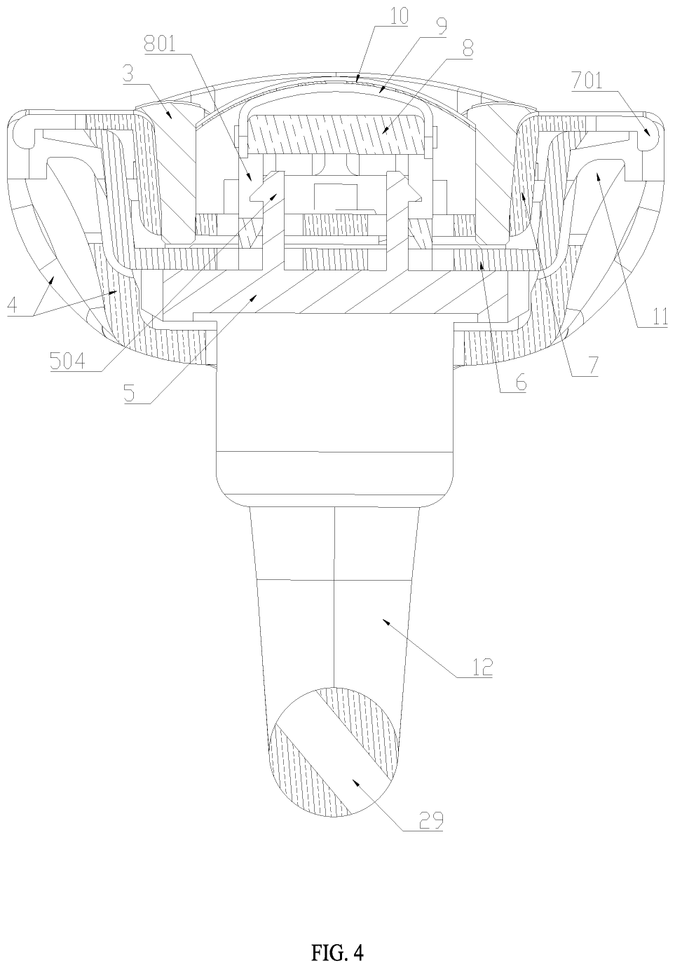

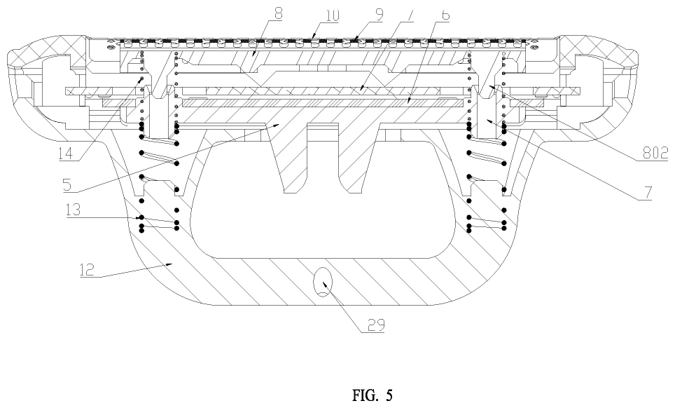

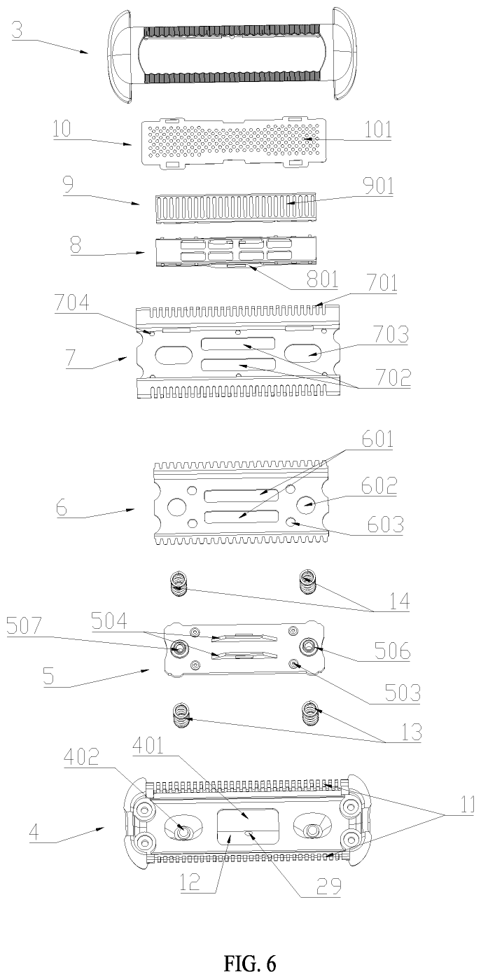

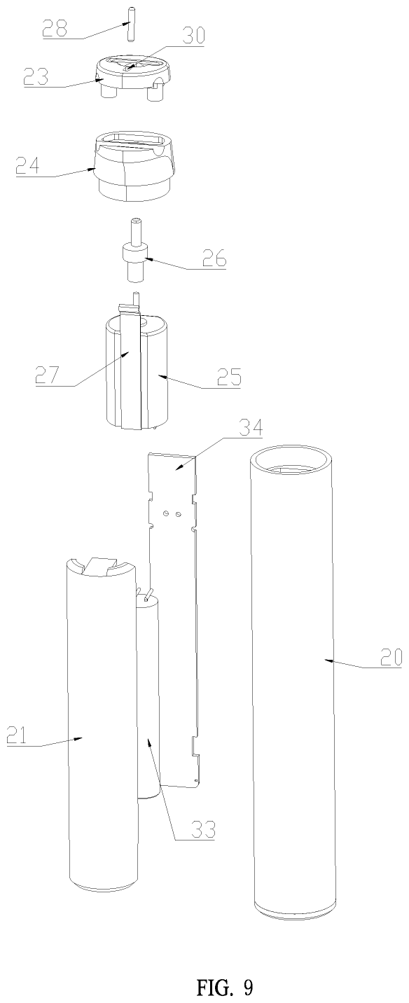

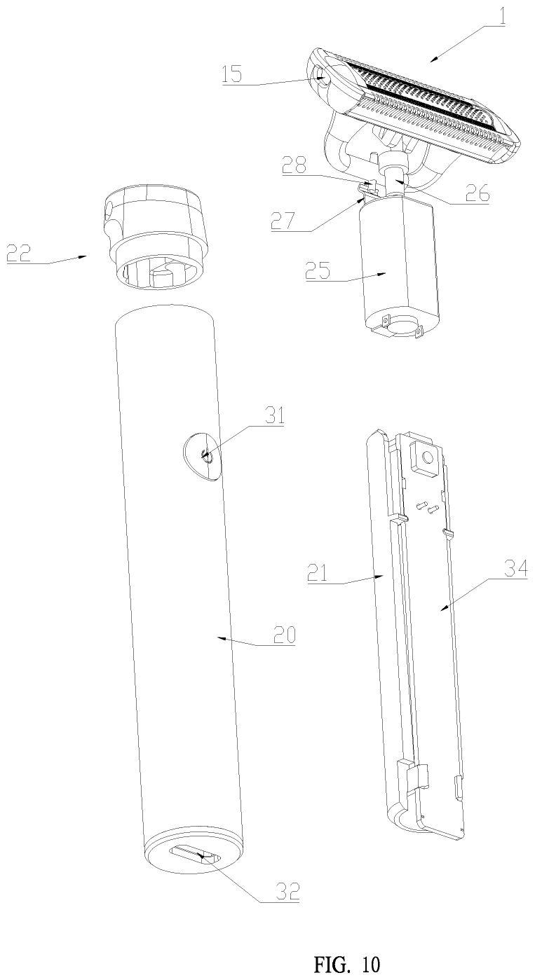

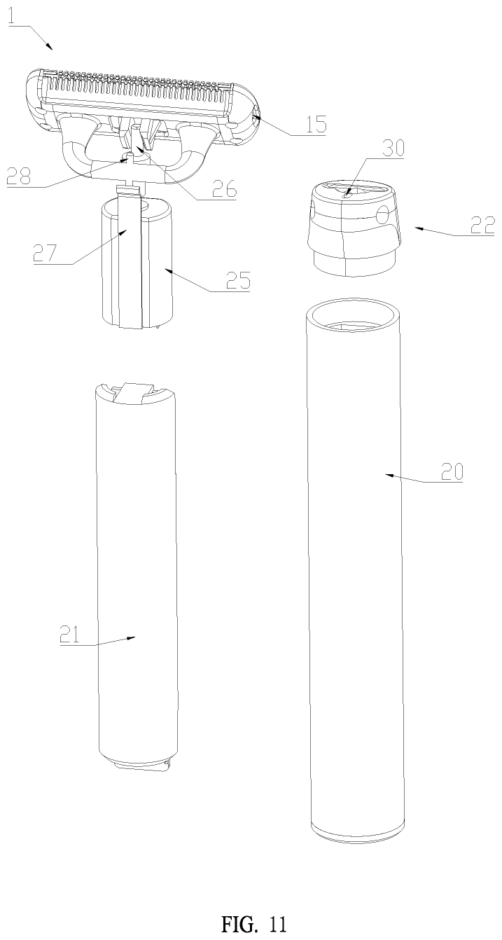

As shown in FIGS. 1-11, a shaver featuring a shaver head with a double-layer elastic structure comprises a shaver head 1 and a main body 2, wherein the shaver head 1 comprises an upper shaver head shell 3 and a lower shaver head shell 4 which are fixedly connected; a connecting rod 12 for being connected with the main body 2 is arranged on a bottom surface of the lower shaver head shell 4; a moving blade connector 5 for driving a blade to move is arranged above the lower shaver head shell 4; the moving blade connector 5 is provided with a first moving blade 6 and a second moving blade fixing part 8 which move together with the moving blade connector 5; a first stationary blade 7 is mounted on the upper shaver head shell 3, and the first moving blade 6 abuts against a lower surface of the first stationary blade 7; the second moving blade fixing part 8 is provided with a second moving blade 9 which moves together with the second moving blade fixing part 8; a second stationary blade 10 abuts against the second moving blade 9; and first elastic parts 13 are arranged between the lower shaver head shell 4 and the moving blade connector 5, and second elastic parts 14 are arranged between the moving blade connector 5 and the second moving blade fixing part 8.

According to the invention, the shaver head 1 drives the second moving blade 9 through the second moving blade fixing part 8 to form a linkage mechanism, and the shaver head 1 adopts a double-layer elastic structure, which can provide stable elastic force for the first moving blade 6 and the second moving blade 9, so as to allow teeth of the first moving blade 6 to be always attached to teeth of the first stationary blade 7 during the reciprocating process and teeth of the second moving blade 9 to be always attached to teeth of the second stationary blade 10 during the reciprocating process without getting stuck, prevent the two groups of blades from interfering with each other, and guarantee force balance; consequently, the shaver achieves enhanced working stability, and improved shaving efficiency and effect.

When using the shaver, one can first use the first moving blade 6 and the first stationary blade 7 to trim body hair first, and then use the second moving blade 9 and the second stationary blade 10 to remove any remaining short hair residue, resulting in a more thorough and effective shaving effect.

The first elastic part 13 may be an elastic piece or a compression spring. When the first elastic part 13 is a compression spring, first sleeve posts 505 are arranged on two sides of a bottom surface of the moving blade connector 5, mounting grooves 402 for inserting the first sleeve posts 505 are formed in the lower shaver head shell 4, and the first elastic parts 13 are sleeved on the first sleeve posts 505; and a lower end of the first elastic part 13 abuts against the corresponding mounting groove 402, and an upper end abuts against the bottom surface of the moving blade connector 5.

The second elastic part 14 is a compression spring, second sleeve posts 506 are arranged on two sides of an upper surface of the moving blade connector 5, and the second sleeve post 506 is provided with a central hole 507; three sleeve posts 802 are arranged on two sides of a bottom surface of the second moving blade fixing part 8 corresponding to the second sleeve posts 506, and the three sleeve posts 802 are inserted into the central hole 507; and the second elastic parts 14 are sleeved on the second sleeve posts 506 and the third sleeve posts 802, a lower end of the second elastic part 14 abuts against the corresponding second sleeve post 506, and an upper end abuts against the corresponding third sleeve post 802.

In this embodiment, two ends of the first moving blade 6 are provided with second through holes 602 corresponding to the second sleeve posts 506, and two ends of the first stationary blade 7 are provided with slotted holes 703 corresponding to the second sleeve posts 506. The second elastic parts 14 pass through the second through holes 602 and the slotted holes 703 to be sleeved on the third sleeve posts 802, and the central holes 507 pass through the first sleeve posts 505 and the second sleeve posts 506.

The first stationary blade 7 is provided with a plurality of stationary blade teeth 701 extending outward, the first moving blade 6 is provided with a plurality of moving blade teeth 604 extending outward, and the stationary blade teeth 701 are longer than the moving blade teeth 604; and a tip of the stationary blade tooth 701 is an arc end, one surface of the arc end is an arc surface protruding towards the stationary blade tooth 701, and an opposite surface of the arc end is flush with a surface of the stationary blade tooth 701.

The moving blade teeth 604 reciprocate relative to the stationary blade teeth 701, and when a cutting surface of the moving blade tooth 604 slides over a cutting surface of the stationary blade tooth 701, hair is cut off. By designing the end of the stationary blade tooth 701 of a first stationary blade part 30 as an arc end 32, the risk of skin cuts from sharp edges is minimized, and a thinner stationary blade tooth 701 that provides a better fit to the skin is obtained. This enhances shaving cleanliness, improves safety performance, and enhances overall comfort.

The second stationary blade 10 and the second moving blade 9 are both made by stainless steel stamping and acute angle etching processes. This significantly reduces the thickness of the blades and enhances their sharpness through the acute angle etching process. When using this shaver head for hair or beard shaving, consumers experience a fast and efficient shaving sensation, while eliminating the problem of hair pulling during shaving.

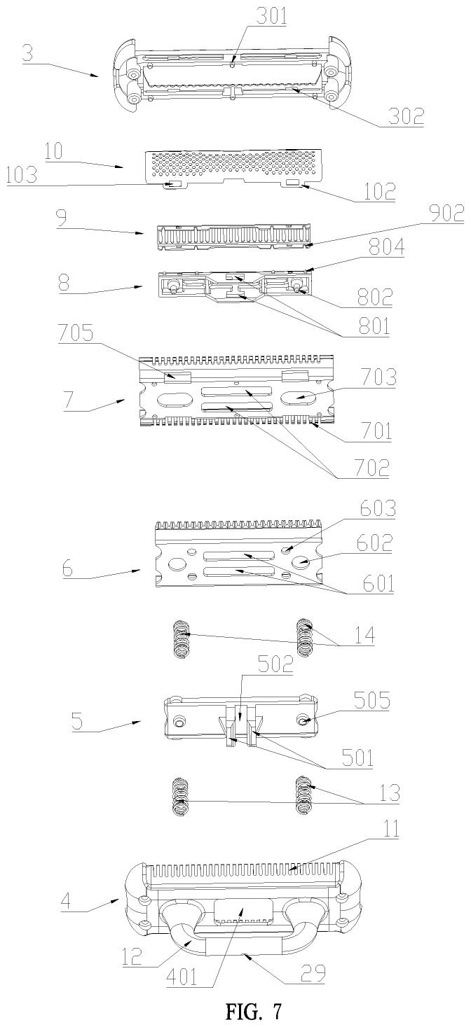

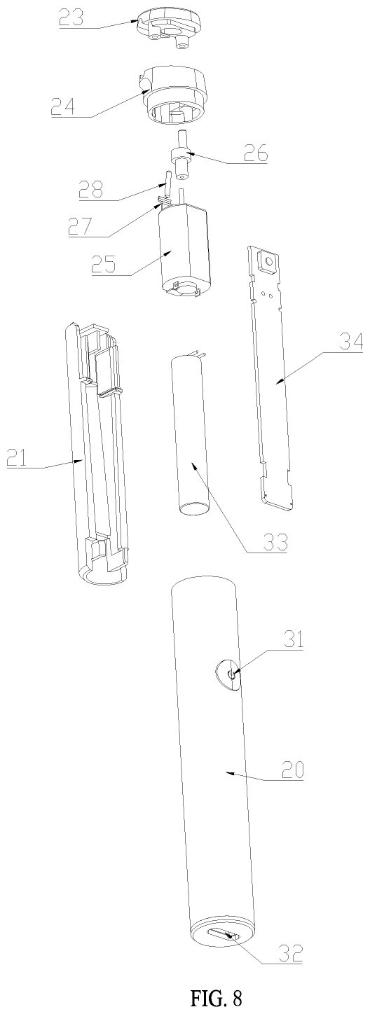

As shown in FIGS. 7 and 8, the second stationary blade 10 and the second moving blade 9 are arranged in the middle of the shaver head 1, the second stationary blade 10 is in a mesh shape, and a plurality of hair inlet holes 101 are densely formed in the second stationary blade 10. This allows for seamless secondary shaving functionality. The second moving blade 9 is provided with a plurality of elongated hole-shaped cutting edges 901, a 45° angle is formed between the cutting edges 901 and the horizontal plane, and the cutting edges 901 abut against an inner side surface of the second stationary blade 10. The 45° angle enhances the cutting performance by 300% compared to a traditional circular blade with a 90° angle. The thickness of the second stationary blade 10 is controlled within millimeter range, ensuring smoothness of the cutting edge of the dual-sided stationary blade.

The first moving blade 6 is provided with a plurality of mounting holes 603, the moving blade connector 5 is correspondingly provided with a plurality of mounting posts 503 inserted into the mounting holes 603, the first stationary blade 7 is provided with a plurality of positioning holes 704, and a bottom surface of the upper shaver head shell 3 is correspondingly provided with a plurality of first positioning posts 301 inserted into the positioning holes 704; and the first moving blade 6 is driven by the moving blade connector 5 through the mounting posts 503 to reciprocate with the moving blade connector 5, and the first stationary blade 7 is fixedly connected to the upper shaver head shell 3 through the first positioning posts 301.

Snap-fit grooves 705 are formed in the first stationary blade 7, snap-fit pieces 102 fitted into the snap-fit grooves 705 are arranged on an outer side of the second stationary blade 10, snap-fit holes 103 are formed in the snap-fit pieces 102, and the upper shaver head shell 3 is provided with snap-fit heads 302 fitted into the snap-fit holes 103;
a step 803 is arranged on an outer side of the second moving blade fixing part 8, a bottom of the second moving blade 9 is placed on the step 803, positioning grooves 902 are formed in an outer side of the second moving blade 9, and the second moving blade fixing part 8 is provided with second positioning posts 804 fitted into the positioning grooves 902; and
two upward extending clip plates 504 are arranged on the moving blade connector 5, downward extending receiving holes 801 are formed in two sides of the second moving blade fixing part 8, the clip plates 504 are fastened into the receiving holes 801, and the second moving blade fixing part 8 is fastened to the moving blade connector 5, so that the second moving blade 9 can reciprocate with the moving blade connector 5.

Further, the first moving blade 6 and the first stationary blade 7 are respectively provided with first elongated holes 601 and second elongated holes 702, and the clip plates 504 pass through the first elongated holes 601 and the second elongated holes 702 to be fastened into the receiving holes 801.

The transmission positioning structure is simple, the interior of the shaver head 1 is more compact in the width direction, and the precision can be controlled within ±0.02 mm.

Cleaning holes 15 are formed in the two ends of the shaver head 1, and after shaving, the shaver head 1 can be directly washed under a faucet, so that hair remaining in the shaver can be easily removed through the cleaning holes 15, ensuring convenient and thorough cleaning.

Hair guiding comb teeth 11 are arranged on two side walls of the lower shaver head shell 4 close to the teeth of the first moving blade 6, which can detangle knotty hair and guide long body hair towards the first moving blade 6 and the first stationary blade 7, thus improving shaving efficiency.

Specifically, the hair guiding comb teeth 11 are located below the first moving blade 6, and the hair guiding comb teeth 11 are in one-to-one correspondence with the teeth of the first stationary blade 7, so that the hair guiding effect is better and the shaving efficiency is improved. The connecting rod 12 is U-shaped. The hair guiding comb teeth 11, the connecting rod 12 and the lower shaver head shell 4 are integrated. The integrated design reduces the number of parts in the shaver head 1, making assembly easier, and allows for integrated injection molding during production, thus improving production efficiency.

According to the hair guiding comb teeth 11, the first moving blade 6, the first stationary blade 7, the second moving blade 9 and the second stationary blade 10 of the invention, the hair guiding comb teeth 11 are in one-to-one correspondence with the teeth of the first stationary blade 10, and can detangle knotty hair and guide long body hair towards the first moving blade 6 and the first stationary blade 7, so as to improve the shaving efficiency; and after body hair is trimmed by the first moving blade 6 and the first stationary blade 7, remaining short hair residue can be removed by the second moving blade 9 and the second stationary blade 10, resulting in a more thorough and effective shaving effect.

A first through hole 401 is formed in the lower shaver head shell 4, two engage blocks 501 extending downward through the first through hole 401 are arranged on a bottom surface of the moving blade connector 5, and an engage groove 502 is arranged between the two engage blocks 501 for being linked with a transmission device in the main body 2.

The main body 2 comprises an outer main body shell 20 and an inner main body shell 21, a key 31 is arranged on a side wall of the outer main body shell 20, a charging interface 32 is arranged at an inner bottom of the outer main body shell 20, a battery 33 is arranged inside the inner main body shell 21, and a circuit board 34 is arranged at one side of the inner main body shell 21.

A shaver head connector 22 is arranged above the outer main body shell 20, and a motor 25 is arranged at an inner top of the outer main body shell 20. A rotating swing part 26 for driving the moving blade connector 5 to reciprocate is mounted on a motor shaft of the motor 25, and an upper end of the rotating swing part 26 is placed in the engage groove 502. A lower end of the rotating swing part 26 can be fixed on the motor shaft of the motor 25 in an interference fit manner. The upper end of the rotating swing part 26 will swing because it is not coaxial with the motor shaft of the motor 25, so as to hit the two engage blocks 501 in the left and right directions, and then drive the moving blade connector 5 to reciprocate, enabling the first moving blade 6 and the second moving blade 9 to reciprocate relative to the first stationary blade 7 and the second stationary blade 10 respectively.

The shaver head 1 is rotatably connected to the shaver head connector 22 through the connecting rod 12, a lower end of the shaver head connector 22 is detachably arranged at the top of the main body 2, a pry bar 28 and an elastic piece 27 are arranged in the shaver head connector 22, the connecting rod 12 is provided with an insertion hole 29, one end of the pry bar 28 abuts against the elastic piece 27, and the other end is inserted into the insertion hole 29.

Specifically, the shaver head connector 22 comprises an upper connector 23 and a lower connector 24, the shaver head 1 is rotatably connected between the upper connector 23 and the lower connector 24 through the connecting rod 12, and the connecting rod 12 can rotate slightly between the upper connector 23 and the lower connector 24, allowing easy adjustment of the angle of the shaver head 1 when the shaver is used. The upper connector 23 is fixed on the lower connector 24, and a lower end of the lower connector 24 is detachably connected to the main body 2 through insertion or fastening, facilitating the replacement of different types of shaver heads.

The upper connector 23 is provided with a limit hole 30, and an upper end of the pry bar 28 passes through the insertion hole 29 and extends into the limit hole 30. The pry bar 28 can be driven to rotate by rotating the shaver head 1. The limit hole 30 is used to limit the rotation angle of the shaver head 1, and the elastic piece 27 is used to make the shaver head 1 return to the original position after rotation.

The embodiments described here are only descriptions of the preferred embodiments of the invention, and are not intended to limit the concept and scope of the invention. Without departing from the design concept of the invention, various modifications and improvements made by engineers and technicians in the field to the technical scheme of the invention should fall within the protection scope of the invention.

1. A shaver featuring a shaver head with a double-layer elastic structure, comprising a shaver head (1) and a main body (2), wherein the shaver head (1) comprises an upper shaver head shell (3) and a lower shaver head shell (4) which are fixedly connected; a connecting rod (12) for being connected with the main body (2) is arranged on a bottom surface of the lower shaver head shell (4); a moving blade connector (5) for driving a blade to move is arranged above the lower shaver head shell (4); the moving blade connector (5) is provided with a first moving blade (6) and a second moving blade fixing part (8) which move together with the moving blade connector; a first stationary blade (7) is mounted on the upper shaver head shell (3), and the first moving blade (6) abuts against a lower surface of the first stationary blade (7); the second moving blade fixing part (8) is provided with a second moving blade (9) which moves together with the second moving blade fixing part; a second stationary blade (10) abuts against the second moving blade (9); and first elastic parts (13) are arranged between the lower shaver head shell (4) and the moving blade connector (5), and second elastic parts (14) are arranged between the moving blade connector (5) and the second moving blade fixing part (8).

2. The shaver featuring the shaver head with the double-layer elastic structure according to claim 1, wherein first sleeve posts (505) are arranged on two sides of a bottom surface of the moving blade connector (5), mounting grooves (402) for inserting the first sleeve posts (505) are formed in the lower shaver head shell (4), and the first elastic parts (13) are sleeved on the first sleeve posts (505); and a lower end of the first elastic part (13) abuts against the corresponding mounting groove (402), and an upper end abuts against the bottom surface of the moving blade connector (5).

3. The shaver featuring the shaver head with the double-layer elastic structure according to claim 1, wherein second sleeve posts (506) are arranged on two sides of an upper surface of the moving blade connector (5), and the second sleeve post (506) is provided with a central hole (507); three sleeve posts (802) are arranged on two sides of a bottom surface of the second moving blade fixing part (8) corresponding to the second sleeve posts (506), and the three sleeve posts (802) are inserted into the central hole (507); and the second elastic parts (14) are sleeved on the second sleeve posts (506) and the third sleeve posts (802), a lower end of the second elastic part (14) abuts against the corresponding second sleeve post (506), and an upper end abuts against the corresponding third sleeve post (802).

4. The shaver featuring the shaver head with the double-layer elastic structure according to claim 1, wherein the first stationary blade (7) is provided with a plurality of stationary blade teeth (701) extending outward, the first moving blade (6) is provided with a plurality of moving blade teeth (604) extending outward, and the stationary blade teeth (701) are longer than the moving blade teeth (604); and a tip of the stationary blade tooth (701) is an arc end, one surface of the arc end is an arc surface protruding towards the stationary blade tooth (701), and an opposite surface is flush with a surface of the stationary blade tooth (701).

5. The shaver featuring the shaver head with the double-layer elastic structure according to claim 1, wherein the second stationary blade (10) and the second moving blade (9) are both made by stainless steel stamping and acute angle etching processes.

6. The shaver featuring the shaver head with the double-layer elastic structure according to claim 5, wherein the second stationary blade (10) and the second moving blade (9) are arranged in the middle of the shaver head (1), the second stationary blade (10) is in a mesh shape, and a plurality of hair inlet holes (101) are densely formed in the second stationary blade (10); and the second moving blade (9) is provided with a plurality of elongated hole-shaped cutting edges (901), a 45° angle is formed between the cutting edges (901) and the horizontal plane, and the cutting edges (901) abut against an inner side surface of the second stationary blade (10).

7. The shaver featuring the shaver head with the double-layer elastic structure according to claim 1, wherein a first through hole (401) is formed in the lower shaver head shell (4), two engage blocks (501) extending downward through the first through hole (401) are arranged on a bottom surface of the moving blade connector (5), and an engage groove (502) is arranged between the two engage blocks (501) for being linked with a transmission device in the main body (2); and
the main body (2) comprises an outer main body shell (20) and an inner main body shell (21), a shaver head connector (22) is arranged over the outer main body shell (20), a motor (25) is arranged at the top of the interior of the outer main body shell (20), a rotating swing part (26) for driving the moving blade connector (5) to reciprocate is mounted on a motor shaft of the motor (25), and an upper end of the rotating swing part (26) is placed in the engage groove (502).

8. The shaver featuring the shaver head with the double-layer elastic structure according to claim 7, wherein the shaver head (1) is rotatably clamped on the shaver head connector (22) through the connecting rod (12), a lower end of the shaver head connector (22) is detachably arranged at the top of the main body (2), a pry bar (28) and an elastic piece (27) are arranged in the shaver head connector (22), the connecting rod (12) is provided with an insertion hole (29), one end of the pry bar (28) abuts against the elastic piece (27), and the other end is inserted into the insertion hole (29).

9. The shaver featuring the shaver head with the double-layer elastic structure according to claim 1, wherein two ends of the shaver head (1) are provided with cleaning holes (15).

10. The shaver featuring the shaver head with the double-layer elastic structure according to claim 1, wherein the first moving blade (6) is provided with a plurality of mounting holes (603), the moving blade connector (5) is correspondingly provided with a plurality of mounting posts (503) inserted into the mounting holes (603), the first stationary blade (7) is provided with a plurality of positioning holes (704), and a bottom surface of the upper shaver head shell (3) is correspondingly provided with a plurality of first positioning posts (301) inserted into the positioning holes (704);
snap-fit grooves (705) are formed in the first stationary blade (7), snap-fit pieces (102) fitted into the snap-fit grooves (705) are arranged on an outer side of the second stationary blade (10), snap-fit holes (103) are formed in the snap-fit pieces (102), and the upper shaver head shell (3) is provided with snap-fit heads (302) fitted into the snap-fit holes (103);
a step (803) is arranged on an outer side of the second moving blade fixing part (8), a bottom of the second moving blade (9) is placed on the step (803), positioning grooves (902) are formed in an outer side of the second moving blade (9), and the second moving blade fixing part (8) is provided with second positioning posts (804) fitted into the positioning grooves (902); and
two upward extending clip plates (504) are arranged on the moving blade connector (5), downward extending receiving holes (801) are formed in two sides of the second moving blade fixing part (8), and the clip plates (504) are fastened into the receiving holes (801).
